(19) United States
(12) Patent Application Publication
(10) Pub. No.: US 2013/0132190 A1
(43) Pub. Date: May 23, 2013

(54) IMAGE TAGGING SYSTEM AND METHOD FOR CONTEXTUALLY RELEVANT ADVERTISING

(71) Applicants: Kristen Lagle Ruiz, Mountain View, CA (US); Chris Waterson, Incline Village, NV (US); Terry Weissman, Mountain View, CA (US)

(72) Inventors: Kristen Lagle Ruiz, Mountain View, CA (US); Chris Waterson, Incline Village, NV (US); Terry Weissman, Mountain View, CA (US)

(21) Appl. No.: 13/299,280

(22) Filed: Nov. 17, 2011

(51) Int. Cl. G06Q 30/02

(52) U.S. Cl. 705/14.49

(57) ABSTRACT

Computer-implement systems and methods for tagging digital images and providing contextually relevant advertisements on a digital content platform, such as a webpage. For example, in one embodiment, the systems and methods generally include: (a) collecting digital images from one or more digital content platforms (e.g., webpages); and (b) providing a subset of the digital images to a thematic tagging engine (e.g., a crowdsource network). The thematic tagging engine is provided with a pre-defined theme, and thereafter tags the digital images based on whether the images match the pre-defined theme. The systems and methods further include: (c) matching at least one ad creative to at least one tagged image based on the pre-defined theme; and (d) providing the ad creative(s) to the digital content platform for publication proximate to the tagged image.

### SUMMARY

Disclosed herein are computer-implement systems and methods for tagging digital images and providing contextually relevant advertisements on a digital content platform, such as a webpage. For example, in one embodiment, the systems and methods generally include: (a) collecting digital images from one or more digital content platforms (e.g., webpages); and (b) providing a subset of the digital images to a thematic tagging engine (e.g., a crowdsource network). The thematic tagging engine is provided with a pre-defined theme, and thereafter tags the digital images based on whether the images match the pre-defined theme. The systems and methods further include: (c) matching at least one ad creative to at least one tagged image based on the pre-defined theme; and (d) providing the ad creative(s) to the digital content platform for publication proximate to the tagged image.

### BRIEF DESCRIPTION OF THE FIGURES

The accompanying drawings, which are incorporated herein, form part of the specification. Together with this written description, the drawings further serve to explain the principles of, and to enable a person skilled in the relevant art(s), to make and use the claimed systems and methods.

FIG. 1 is a high-level diagram illustrating an embodiment of the present invention.

FIG. 2 is a high-level schematic diagram of an example thematic tagging engine.

FIG. 3 is a high-level schematic diagram of an example crowdsource network interface.

FIG. 4 is a flowchart illustrating a method, in accordance with one embodiment presented herein.

FIG. 5 is a high-level diagram illustrating one implementation of an embodiment presented.

FIG. 6 is a schematic drawing of a computer system used to implement the systems and methods presented.

### DEFINITIONS

Prior to describing the present invention in detail, it is useful to provide definitions for key terms and concepts used herein. Unless defined otherwise, all technical and scientific terms used herein have the same meaning as commonly understood by one of ordinary skill in the art to which this invention belongs.

“Advertisement” or “ad”: One or more images, with or without associated text, to promote or display a product or service. Terms “advertisement” and “ad,” in the singular or plural, are used interchangeably.

“Ad Creative” or “Creative”: Computer file with advertisement, image, or any other content or material related to a product or service.

Ad server: One or more computers, or equivalent systems, which maintains a catalog of creatives, delivers creative(s), and/or tracks advertisement(s), campaigns, and/or campaign metrics independent of the platform where the advertisement is being displayed.

Campaign: The process or program of planning, creating, buying, and/or tracking an advertising project.

“Campaign metrics” or “insertion order”: The details of an advertising campaign; e.g., the terms of an agreement between the merchant and service provider. Campaign metrics include, but are not limited to, details such as: budget (e.g., daily, weekly, monthly, etc.); cost-per-click (CPC); cost-per-action (CPA); cost-per-day (CPD); cost-per-thousand (CPM) impressions of an advertisement; cost-per-sale (CPS); inventory (e.g., in/out of stock status); location (e.g., country, region, state, city, etc.); price (e.g., competitive bidding); duration of campaign; merchant promotions; time (e.g., hours per day, time of day, days per week, season, etc.); frequency of display; etc.

Cataloging: Act of organizing, sorting, indexing, and/or classifying creatives or images.

“Contextual information” or “contextual tag”: Data related to the contents and/or context of digital content (e.g., an image, or content within the image); for example, but not limited to, a description, identification, index, or name of an image, or object, or scene, or person, or abstraction within the digital content (e.g., image).

Contextually relevant advertisement: A targeted advertisement that is considered relevant to the contents and/or context of digital content on a digital content platform.

Crowdsource network: One or more individuals, whether human or computer, used for a crowdsourcing application.

Crowdsourcing: The process of delegating a task to one or more individuals, with or without compensation.

Digital content: Broadly interpreted to include, without exclusion, any content available on a digital content platform, such as images, videos, text, audio, and any combinations and equivalents thereof.

Digital content platform: Broadly interpreted to include, without exclusion, any webpage, website, browser-based web application, software application, mobile device application (e.g., phone or tablet application), TV widget, and equivalents thereof.

Image: A visual representation of an object, or scene, or person, or abstraction, in the form of a machine-readable and/or machine-storable work product (e.g., one or more computer files storing a digital image, a browser-readable or displayable image file, etc.). As used herein, the term “image” is merely one example of “digital content.”

Merchant: Seller or provider of a product or service; agent representing a seller or provider; or any third-party charged with preparing and/or providing digital content associated with a product or service. For example, the term merchant should be construed broadly enough to include an ad agency, or other intermediaries, charged with developing a digital content to advertise a product or service.

Proximate: Is intended to broadly mean “relatively adjacent, close, or near,” as would be understood by one of skill in the art. The term “proximate” should not be narrowly construed to require an absolute position or abutment. For example, “content displayed proximate to an image,” means “content displayed relatively near an image, but not necessarily abutting or within the image.” (To clarify: “content displayed proximate to an image,” also includes “content displayed abutting or within the image.”) In another example, “content displayed proximate to an image,” means “content displayed on the same screen page or webpage as the image.”

Publisher: Party that owns, provides, and/or controls a digital content platform; or third-party charged with providing, maintaining, and/or controlling ad space on a digital content platform.

### CROSS-REFERENCE TO RELATED APPLICATIONS

Except for any term definitions that conflict with the term definitions provided herein, the following related, co-owned, and co-pending applications are incorporated by reference in their entirety: U.S. patent application Ser. Nos. 12/902,066; 13/005,217; 13/005,226; 13/045,426; 29/387,270; 29/387,271; 29/387,272; 29/387,273; 13/151,110; 13/219,460; and 13/252,053.

### DETAILED DESCRIPTION

U.S. patent application Ser. No. 13/252,053 (“the '053 application”), incorporated by reference above, discloses embodiments for providing contextually relevant advertising on a webpage of a publisher's website. For example, the '053 application discloses a method comprising: (a) creating an image catalog populated with product images from merchants; and (b) providing an interface for a crowdsource network to (1) identify a published image on a webpage of a publisher's website, (2) tag the published image with a contextual tag, and (3) match the published image with at least one matching product image from the image catalog based on the contextual tag. The method of the '053 application further includes: (c) providing a user-actionable interface on the webpage for a user to activate the published image; and (d) upon activation by the user, providing an image frame on the webpage to display the matching product image of step (b)(3). The matching product image of step (b)(3) may be an ad creative, and may serve as a hyperlink to a corresponding merchant's website.

The limited effective lifespan of a digital image published on a digital content platform, such as an image on a webpage, requires expedited implementation and execution of the above-presented method. As such, presented herein are systems and methods to expedite the identification, tagging, and matching of published images with relevant content (e.g., relevant ad creatives). The systems and methods presented herein also help maximize the use of ad campaign resources by quickly identifying published images that are relevant (or “best fits”) for pre-defined ad campaigns and themes.

For example, disclosed herein are computer-implement systems and methods for tagging digital images and providing contextually relevant advertisements on a digital content platform, such as a webpage. In one embodiment, the systems and methods generally include: (a) collecting digital images from one or more digital content platforms (e.g., webpages); and (b) providing a subset of the digital images to a thematic tagging engine (e.g., a crowdsource network). The thematic tagging engine is provided with a pre-defined theme, and thereafter tags the digital images based on whether the images match the pre-defined theme. The systems and methods further include: (c) matching at least one ad creative to at least one tagged image based on the pre-defined theme; and (d) providing the ad creative(s) to the digital content platform for publication proximate to the tagged image.

The following detailed description of the figures refers to the accompanying drawings that illustrate exemplary embodiments. Other embodiments are possible. Modifications may be made to the embodiments described herein without departing from the spirit and scope of the present invention. Therefore, the following detailed description is not meant to be limiting.

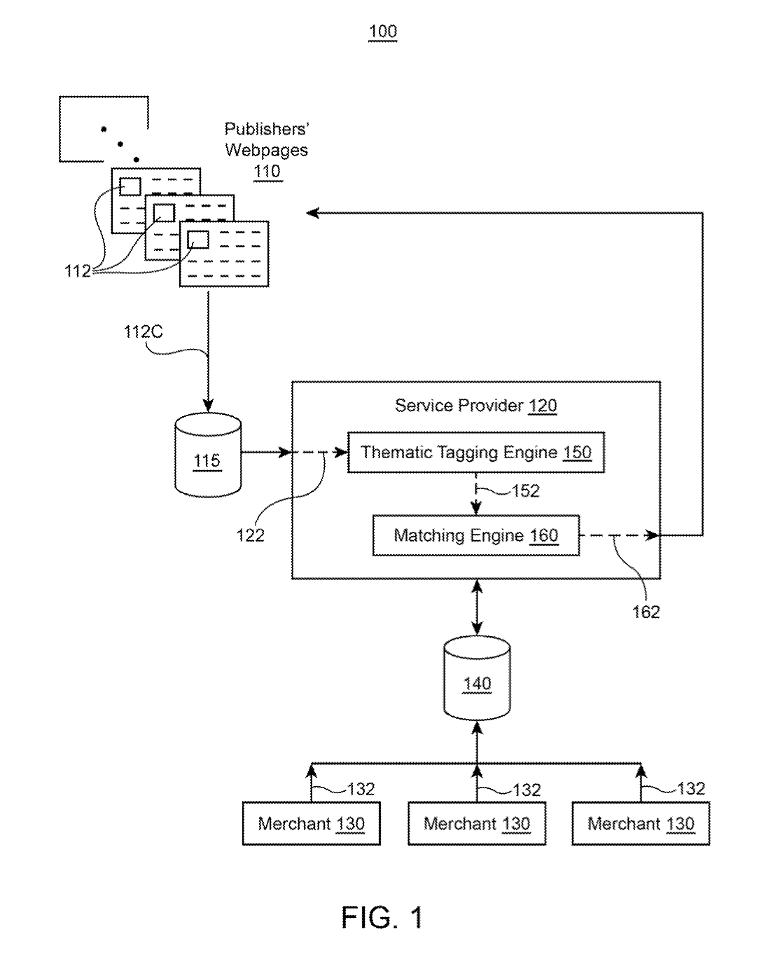

FIG. 1 shows a computer-implemented system 100 for tagging digital images, and providing contextually relevant advertisements on a digital content platform, such as a webpage 110. For the sake of simplicity, certain aspects and/or components of the presented system are not shown. For example, as would be understood by one of skill in the art, webpages 110 are typically provided within a web browser on an end-user's device. The end-user's device (e.g., computer, tablet, mobile phone, etc.) is then connected (wired or wirelessly) to a network (e.g., the Internet) to transmit data, files, instructions, etc. Such system aspects and/or components are not shown.

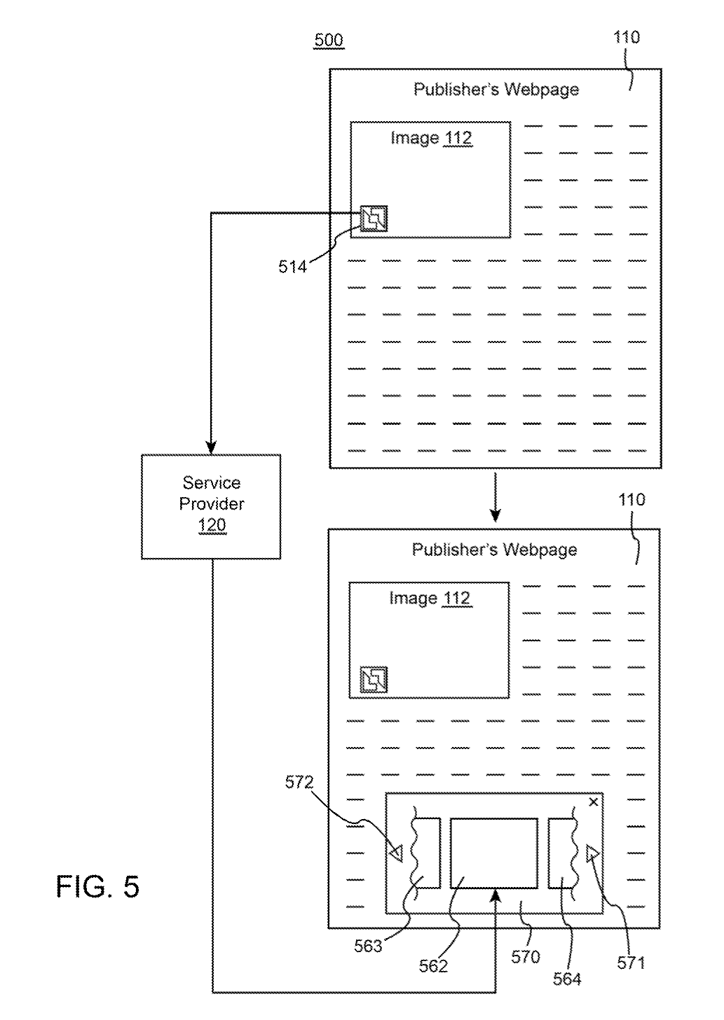

Webpages 110 generally include digital content, such as text (shown in phantom) and at least one image 112. In practice, image 112 is displayed within an image frame on webpage 110. In some instances, the systems and methods presented herein allow a user to activate a user-actionable interface (such as “hotspot” interface 514 shown in FIG. 5) to display content within a second image frame (such as image frame 570 in FIG. 5). In certain embodiments, the content displayed within the second image frame may be advertisements (or ad creatives) that are contextually relevant to image 112 and/or any digital content on webpage 110. Further, in certain embodiments, images displayed within the second image frame may include hyperlinks to a merchant or third-party website.

In operation, published images 112 may be collected, added to, and maintained in an image database 115. Image collection (or “capture”) procedures 112C include: scraping images from webpages 110; a web crawling robot; computer code for “walking the DOM tree”; a computerized “widget” to automatically queue images when the webpages are first loaded; an interface for a publisher to submit published images; and/or any combinations or equivalents thereof. The “collecting” or “capturing” of images broadly includes the identifying of, making a copy of, and/or saving a copy of the image into image database 115. The “collecting” or “capturing” of images may also broadly include identifying image locations (e.g., image URLs) such that the images need to be stored temporarily or permanently in image database 115, but may still be accessed when needed.

Within image database 115, the images 112 (or image identifiers) may be cataloged, categorized, sub-categorized, and/or scored based on image metadata and/or existing image tags. The cataloging, categorizing, sub-categorizing, and/or scoring of the images may also be subject to input from one or more merchants 130, and one or more corresponding campaign variables or metrics. In one embodiment, the scoring may be based on data obtained from the digital content platform that published the digital image. The data may be selected from the group consisting of: digital publisher identification, publisher priority, image category, image metadata, quality of digital image, size of digital image, date of publication of the digital image, time of publication of digital image, image traffic statistics, and any combination or equivalents thereof. Images 112 may also be tagged with the location of origin of the image. Images 112 may also be thumb-nailed, resized, or otherwise modified to optimize processing.

In one embodiment, image database 115 is maintained by service provider 120. Alternatively, the service provider need not maintain, but only have access to, image database 115. Images 112 (or a subset thereof) are then processed, by service provider 120, through a thematic tagging engine 150 and matching engine 160.

Within thematic tagging engine 150, images 112 are tagged based on a pre-defined theme (or selection criteria). Themes may broadly include any objective or subjective categories, including campaign metrics and/or abstract concepts (e.g., “happy,” “sad,” “winning,” “couples,” etc.). In alternative embodiments, the themes may be selected from the group consisting of: people (e.g., celebrities, athletes, politicians); places (e.g., cities, venues, monuments, general geo-coordinates); events (e.g., Emmy Awards, Super Bowl, celebrity parties); classes of objects (e.g., sport cars, apparel); specific products (e.g., brand name products); abstract concepts (e.g., “winning,” “happy couples,” “family life”); photographic genres (e.g., portraits, scenery); offensive scenes (e.g., images of pornography, weapons, crime, etc.); and/or any combinations or equivalents thereof. A “pre-defined” theme may be established or selected by any of the parties partaking in the present invention (e.g., service provider, merchants, publishers, etc.) or may be automatically established, generated, or identified by a computer implemented algorithm. For example, in one embodiment, end-user metrics are employed in order to identify what image themes produce optimal user interaction (e.g., clicks, views, shares, etc.).

After processing through thematic tagging engine 150, the tagged images are processed through matching engine 160. Within matching engine 160, the tagged images are matched (or linked) to corresponding ad creatives, drawn from ad server 140, based on the pre-defined theme. For example, images tagged under the theme “winning” are matched to ad creatives corresponding to the “winning” theme. The matching procedure may include making a database association or creating a database entry that maintains a relationship between the tag(s), image(s) 112, and/or ad creative(s). The matching procedure may alternatively include a relational database and/or any alternative database management technology. In an alternative embodiment, matching engine functions are performed within ad server 140. Campaign variables, metrics, themes, instructions, and/or ad creatives may be provided, maintained, and/or stored within ad server 140 by merchants 130, via interface 132, or by service provider 120. The matched ad creative(s) is then provided to the original digital content platform (e.g., webpage 110) for publication proximate to the tagged image. In practice, application programming interfaces (APIs) (e.g., 122, 132, 152, 162), or equivalent network/communication means, are provided to communicate between system and sub-system components. As such, system 100 provides a means for presenting contextually relevant advertising proximate a digital image published on a digital content platform.

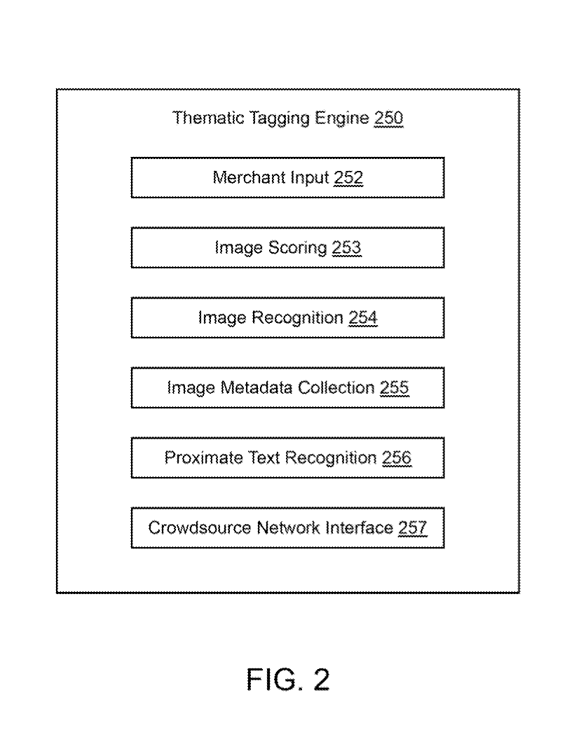

FIG. 2 is a high-level schematic diagram of an example thematic tagging engine 250. More specifically, FIG. 2 provides example components/inputs of a thematic tagging engine 250; any one of, or combination of, may be used to perform the above-identified tagging functions. For example, thematic tagging engine 250 may incorporate merchant input 252; such as, themes, campaign variables or metrics, or any equivalent selection criteria. Thematic tagging engine may also incorporate data from sub-systems for image scoring 253, image recognition 254, image metadata collection 255, and/or proximate text recognition 256. In one embodiment, proximate text recognition 256 collects image data based on systems (or sub-systems) of the embodiments described in co-pending U.S. application Ser. No. 13/005,217, incorporated by reference above.

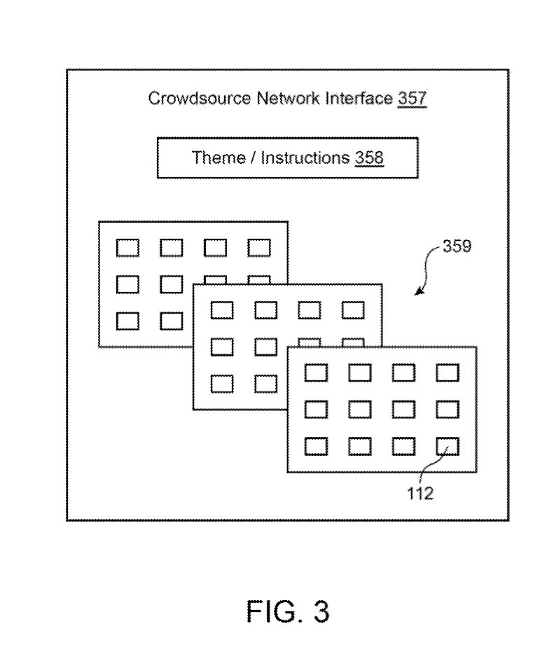

In one embodiment, thematic tagging engine 250 includes a crowdsource network interface 257, to receive input from a crowdsource network. FIG. 3 is a high-level schematic diagram of an example crowdsource network interface 357. As shown in FIG. 3, a pre-defined theme (or selection criteria, or equivalent instructions) 358 is provided to a crowdsource network. One or more frames 359 may then be displayed (preferably sequentially) to the crowdsource network. Each frame 359 includes two or more, and preferably ten or more (e.g., twelve) images 112. The crowdsource network is then asked to tag images that correspond to the provided theme 358. As such, crowdsource network interface 357 is used as a means for increasing throughput of image tagging within the thematic tagging engine. Calibration procedures may also be performed to ensure the quality and consistency of the image tagging. Further, a second-pass validation may be performed to ensure the quality and consistency of the image tagging. Second (or subsequent) pass validations may include the same or different metrics/themes, and may further be used to obtain metrics on or for the merchants, publishers, and/or tagging engine sub-systems.

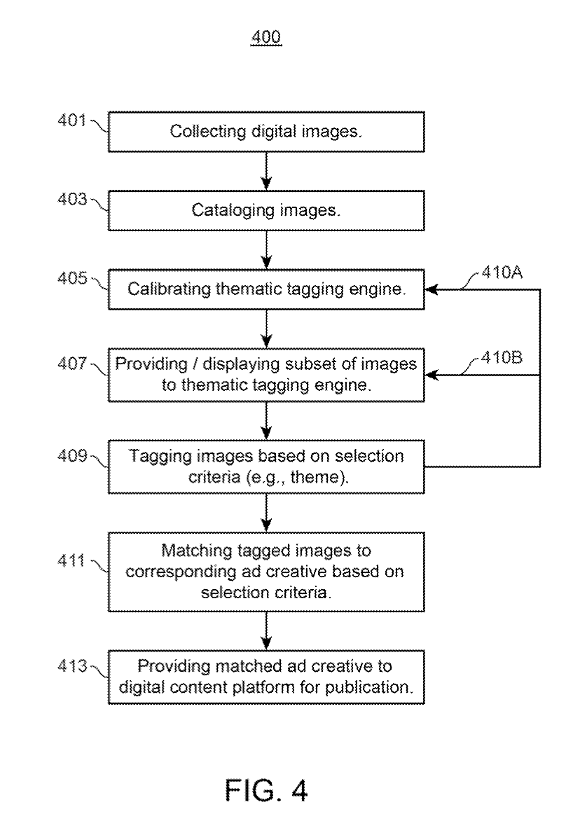

FIG. 4 is a flowchart illustrating a method 400, in accordance with one embodiment presented herein. In step 401, digital images are collected from one or more digital content platforms (e.g., webpages, web apps, mobile apps, etc.). In step 403, the collected digital images are cataloged in an image database. In step 405, a thematic tagging engine is calibrated by, for example, providing instructions, themes, and/or equivalent selection criteria to the thematic tagging engine. In step 407, a subset of digital images is provided/displayed to the thematic tagging engine. For example, in one embodiment, digital images are displayed to a crowdsourcing network. In step 409, images are tagged based on the provided selection criteria (e.g., theme). Arrows 410A and/or 410B represent a second-pass validation wherein the thematic tagging engine is recalibrated and/or images are re-provided/re-displayed to the thematic tagging engine. In step 411, tagged images are matched to corresponding ad creative(s) based on the provided selection criteria (e.g., theme). In step 413, the matched ad creative(s) is provided to the digital content platform for publication proximate to the tagged image.

FIG. 5 is a high-level diagram illustrating an implementation 500, of an embodiment presented. FIG. 5 shows an image 112 originally published on a publisher's webpage 110. When an end-user activates a hotspot 514, a call is made upon service provider 120 to provide one or more ad creatives 562, 563, and 564, within an image frame 570. The user can then use interface 571, 572 to browse amongst ad creatives (or any digital content otherwise provided) 562, 563, and 564. Service provider 120 implements any of the above described systems, methods, sub-systems, and/or sub-protocols (e.g., 100, 250, 357, and/or 400) to identify and provide contextually relevant ad creatives 562, 563, and/or 564. In one embodiment, ad creatives 562, 563, and/or 564 are contextually related to each other, to image 112, and/or to digital content on webpage 110. Image frame 570 may be used as a means to browse ad creatives on webpage 110, without having to leave webpage 110. Further, each ad creative within image frame 570 may provide a link to another webpage, such as a merchant's webpage. As such, image frame 570 may provide a means for displaying advertisements that are contextually relevant to image 112, digital content on webpage 110, and/or other images displayed within image frame 570.

### Additional Embodiments

In another embodiment, there is provided a computer-implement method for tagging digital images and providing contextually relevant advertisements, proximate the digital images, on a digital content platform. The method comprises: (a) collecting digital images from one or more digital content platforms; (b) providing a subset of the digital images to a thematic tagging engine, wherein the thematic tagging engine is provided with a pre-defined theme, and wherein the thematic tagging engine tags at least one digital image from the subset based on the pre-defined theme; (c) matching an ad creative to at least one tagged digital image based on the pre-defined theme; and (d) providing the ad creative to the digital content platform for publication proximate to the tagged digital image. Step (a) may include scraping the digital images from the digital content platform. Step (a) may include providing an interface for a publisher to submit the digital images.

The thematic tagging engine may include a crowdsource network. The thematic tagging engine may also include an interface for receiving input from the crowdsource network. In one embodiment, step (b) includes displaying the subset of digital images to the crowdsource network. The subset of digital images may be displayed twelve images at a time. Alternatively, subset may include two or more digital images; five or more digital images; or ten or more digital images.

In another embodiment, there is provided a computer-implement method for providing contextually relevant advertisements on a digital content platform, wherein the method comprises: (a) collecting a plurality of digital images from a digital content platform; (b) providing an interface to display the plurality of digital images to a crowdsource network, wherein the crowdsource network is provided with a pre-defined theme, and wherein the crowdsource network tags at least one of the digital images based on the pre-defined theme; (c) providing an interface to identify each digital image that has been tagged by the crowdsource network; (d) maintaining an ad server with at least one ad creative corresponding to the pre-defined theme; (e) matching the ad creative to at least one tagged digital image from step (c), based on the pre-defined theme; and (f) providing the ad creative to the digital content platform for publication. Step (a) may include scraping the digital images from the digital content platform. Step (a) may also include providing an interface for a publisher to submit the digital images. The crowdsource network may be displayed twelve digital images at a time.

The method may further include (g) scoring the digital images; (h) calibrating decisions made by the crowdsource network; and/or (i) conducting a second-pass validation. The scoring may be based on data obtained from the digital content platform that published the digital image. The data may be selected from the group consisting of: digital publisher identification, publisher priority, image category, image metadata, quality of digital image, size of digital image, date of publication of the digital image, time of publication of digital image, image traffic statistics, and any combination thereof.

In another embodiment, there is provided a computer-implement system for providing contextually relevant advertisements on a digital content platform, comprising: (a) an interface for collecting a plurality of digital images from one or more digital content platforms; (b) an interface for displaying subsets of the plurality of digital images to a crowdsource network; (c) an interface for identifying digital images tagged by the crowdsource network based on a theme provided to the crowdsource network; (d) an ad server storing a plurality of ad creatives, each ad creative including a corresponding theme identifier, wherein the ad server is configured to match an ad creative to at least one tagged digital image based on the theme of the digital image; and (e) an interface for providing the ad creative, and corresponding match information, to the one or more digital content platforms for publication of the ad creative.

In still another embodiment, there is provided a method comprising: (a) creating an image catalog populated with a plurality of product images from a plurality of merchants; (b) providing an interface for a crowdsource network to (1) identify a plurality of published images across a plurality of digital content platforms, (2) tag the plurality of published images based on theme, and (3) match the published image with at least one matching product image from the image catalog. The method further comprises: (c) providing a user-actionable interface on a digital content platform for a user to activate the published image; and (d) upon activation by the user, providing an image frame on the digital content platform to display the matching product image of step (b)(3). The method may be used for providing contextually relevant advertising on a webpage of a publisher's website. The matching product image of step (b)(3) may provide a hyperlink to a third-party and/or merchant's website.

Communication Between Parties Practicing the Present Invention.

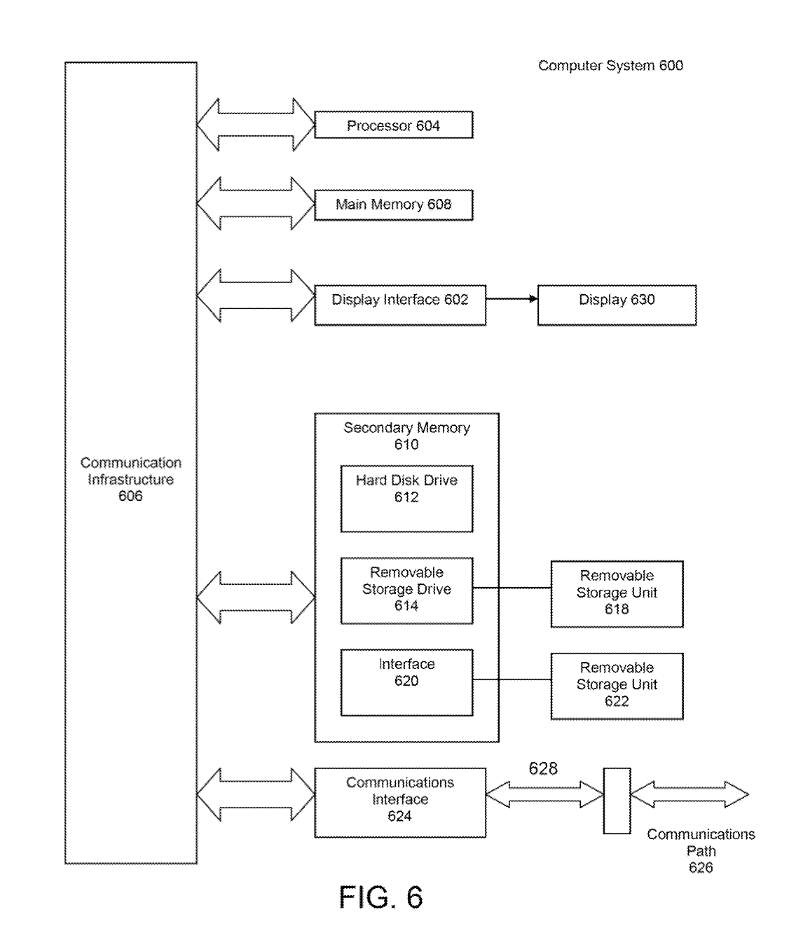

In one embodiment, communication between the various parties and components of the present invention is accomplished over a network consisting of electronic devices connected either physically or wirelessly, wherein digital information is transmitted from one device to another. Such devices (e.g., end-user devices and/or servers) may include, but are not limited to: a desktop computer, a laptop computer, a handheld device or PDA, a cellular telephone, a set top box, an Internet appliance, an Internet TV system, a mobile device or tablet, or systems equivalent thereto. Exemplary networks include a Local Area Network, a Wide Area Network, an organizational intranet, the Internet, or networks equivalent thereto. The functionality and system components of an exemplary computer and network are further explained in conjunction with FIG. 6, below.

Computer Implementation.

In one embodiment, the invention is directed toward one or more computer systems capable of carrying out the functionality described herein. For example, FIG. 6 is a schematic drawing of a computer system 600 used to implement the methods presented above. Computer system 600 includes one or more processors, such as processor 604. The processor 604 is connected to a communication infrastructure 606 (e.g., a communications bus, cross-over bar, or network). Computer system 600 can include a display interface 602 that forwards graphics, text, and other data from the communication infrastructure 606 (or from a frame buffer not shown) for display on a local or remote display unit 630.

Computer system 600 also includes a main memory 608, such as random access memory (RAM), and may also include a secondary memory 610. The secondary memory 610 may include, for example, a hard disk drive 612 and/or a removable storage drive 614, representing a floppy disk drive, a magnetic tape drive, an optical disk drive, flash memory device, etc. The removable storage drive 614 reads from and/or writes to a removable storage unit 618. Removable storage unit 618 represents a floppy disk, magnetic tape, optical disk, flash memory device, etc., which is read by and written to by removable storage drive 614. As will be appreciated, the removable storage unit 618 includes a computer usable storage medium having stored therein computer software, instructions, and/or data.

In alternative embodiments, secondary memory 610 may include other similar devices for allowing computer programs or other instructions to be loaded into computer system 600. Such devices may include, for example, a removable storage unit 622 and an interface 620. Examples of such may include a program cartridge and cartridge interface (such as that found in video game devices), a removable memory chip (such as an erasable programmable read only memory (EPROM), or programmable read only memory (PROM)) and associated socket, and other removable storage units 622 and interfaces 620, which allow computer software, instructions, and/or data to be transferred from the removable storage unit 622 to computer system 600.

Computer system 600 may also include a communications interface 624. Communications interface 624 allows computer software, instructions, and/or data to be transferred between computer system 600 and external devices. Examples of communications interface 624 may include a modem, a network interface (such as an Ethernet card), a communications port, a Personal Computer Memory Card International Association (PCMCIA) slot and card, etc. Software and data transferred via communications interface 624 are in the form of signals 628 which may be electronic, electromagnetic, optical or other signals capable of being received by communications interface 624. These signals 628 are provided to communications interface 624 via a communications path (e.g., channel) 626. This channel 626 carries signals 628 and may be implemented using wire or cable, fiber optics, a telephone line, a cellular link, a radio frequency (RF) link, a wireless communication link, and other communications channels.

In this document, the terms “computer-readable storage medium,” “computer program medium,” and “computer usable medium” are used to generally refer to media such as removable storage drive 614, removable storage units 618, 622, data transmitted via communications interface 624, and/or a hard disk installed in hard disk drive 612. These computer program products provide computer software, instructions, and/or data to computer system 600. These computer program products also serve to transform a general purpose computer into a special purpose computer programmed to perform particular functions, pursuant to instructions from the computer program products/software. Embodiments of the present invention are directed to such computer program products.

Computer programs (also referred to as computer control logic) are stored in main memory 608 and/or secondary memory 610. Computer programs may also be received via communications interface 624. Such computer programs, when executed, enable the computer system 600 to perform the features of the present invention, as discussed herein. In particular, the computer programs, when executed, enable the processor 604 to perform the features of the presented methods. Accordingly, such computer programs represent controllers of the computer system 600. Where appropriate, the processor 604, associated components, and equivalent systems and sub-systems thus serve as “means for” performing selected operations and functions. Such “means for” performing selected operations and functions also serve to transform a general purpose computer into a special purpose computer programmed to perform said selected operations and functions.

In an embodiment where the invention is implemented using software, the software may be stored in a computer program product and loaded into computer system 600 using removable storage drive 614, interface 620, hard drive 612, communications interface 624, or equivalents thereof. The control logic (software), when executed by the processor 604, causes the processor 604 to perform the functions and methods described herein.

In another embodiment, the methods are implemented primarily in hardware using, for example, hardware components such as application specific integrated circuits (ASICs) Implementation of the hardware state machine so as to perform the functions and methods described herein will be apparent to persons skilled in the relevant art(s). In yet another embodiment, the methods are implemented using a combination of both hardware and software.

Embodiments of the invention, including any systems and methods described herein, may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing firmware, software, routines, instructions, etc.

For example, in one embodiment, there is provided a computer-readable storage medium, having instructions executable by at least one processing device that, when executed, cause the processing device to: (a) collect digital images from one or more digital content platforms; (b) provide a subset of the digital images to a thematic tagging engine, wherein the thematic tagging engine is provided with a pre-defined theme, and wherein the thematic tagging engine tags at least one digital image from the subset based on the pre-defined theme; (c) match an ad creative to at least one tagged digital image based on the pre-defined theme; and (d) provide the ad creative to the digital content platform for publication proximate to the tagged digital image. The collection of digital images may be performed by scraping the digital images from the digital content platform. The collection of digital images may be performed by providing an interface for a publisher to submit the digital images.

The thematic tagging engine may include a crowdsource network. The thematic tagging engine may also include an interface for receiving input from the crowdsource network. In one embodiment, a subset of digital images is displayed to the crowdsource network. The subset of digital images may be displayed twelve images at a time. Alternatively, subset may include two or more digital images; five or more digital images; or ten or more digital images.

In another embodiment, there is provided a computer-readable storage medium, having instructions executable by at least one processing device that, when executed, cause the processing device to: (a) collect a plurality of digital images from a digital content platform; (b) provide an interface to display the plurality of digital images to a crowdsource network, wherein the crowdsource network is provided with a pre-defined theme, and wherein the crowdsource network tags at least one of the digital images based on the pre-defined theme; (c) provide an interface to identify each digital image that has been tagged by the crowdsource network; (d) maintain an ad server with at least one ad creative corresponding to the pre-defined theme; (e) match the ad creative to at least one tagged digital image, based on the pre-defined theme; and (f) provide the ad creative to the digital content platform for publication. The collection of digital images may be performed by scraping the digital images from the digital content platform. The collection of digital images may be performed by providing an interface for a publisher to submit the digital images. The crowdsource network may be displayed twelve digital images at a time.

The computer-readable storage medium may further include instructions executable by at least one processing device that, when executed, cause the processing device to: (g) score the digital images; (h) calibrate decisions made by the crowdsource network; and/or (i) conduct a second-pass validation. The scoring may be based on data obtained from the digital content platform that published the digital image. The data may be selected from the group consisting of: digital publisher identification, publisher priority, image category, image metadata, quality of digital image, size of digital image, date of publication of the digital image, time of publication of digital image, image traffic statistics, and any combination thereof.

In still another embodiment, there is provided a computer-readable storage medium, having instructions executable by at least one processing device that, when executed, cause the processing device to: (a) create an image catalog populated with a plurality of product images from a plurality of merchants; (b) provide an interface for a crowdsource network to (1) identify a plurality of published images across a plurality of digital content platforms, (2) tag the plurality of published images based on theme, and (3) match the published image with at least one matching product image from the image catalog. The computer-readable storage medium further comprises instructions executable by at least one processing device that, when executed, cause the processing device to: (c) provide a user-actionable interface on a digital content platform for a user to activate the published image; and (d) upon activation by the user, provide an image frame on the digital content platform to display the matching product image. The computer-readable storage medium may be used for providing contextually relevant advertising on a webpage of a publisher's website. The matching product image may provide a hyperlink to a third-party and/or merchant's website.

Conclusion.

The foregoing description of the invention has been presented for purposes of illustration and description. It is not intended to be exhaustive or to limit the invention to the precise form disclosed. Other modifications and variations may be possible in light of the above teachings. The embodiments were chosen and described in order to best explain the principles of the invention and its practical application, and to thereby enable others skilled in the art to best utilize the invention in various embodiments and various modifications as are suited to the particular use contemplated. It is intended that the appended claims be construed to include other alternative embodiments of the invention; including equivalent structures, components, methods, and means.

Accordingly, it is to be understood that this invention is not limited to particular embodiments described, and as such may vary. It is also to be understood that the terminology used herein is for the purpose of describing particular embodiments only, and is not intended to be limiting.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

It is to be appreciated that the Detailed Description section, and not the Summary and Abstract sections, is intended to be used to interpret the claims. The Summary and Abstract sections may set forth one or more, but not all exemplary embodiments of the present invention as contemplated by the inventor(s), and thus, are not intended to limit the present invention and the appended claims in any way.

1. A computer-implemented method for providing contextually relevant advertisements on a digital content platform, the method comprising:
(a) collecting digital images from one or more digital content platforms;
(b) providing a subset of the digital images to a thematic tagging engine, wherein the thematic tagging engine is provided with a pre-defined advertising theme from a service provider, merchant, and/or publisher, and wherein the thematic tagging engine selects at least one digital image from the subset based on the pre-defined advertising theme;
(c) matching an ad creative to at least one digital image selected in step (b); and
(d) providing the ad creative to the digital content platform for publication proximate to the selected digital image.

2. The method of claim 1, wherein step (a) includes scraping the digital images from the digital content platform.

3. The method of claim 1, wherein step (a) includes providing an interface for a publisher to submit the digital images.

4. The method of claim 1, wherein step (b) includes displaying the subset of digital images to a crowdsource network.

5. The method of claim 4, wherein the subset of digital images are displayed twelve images at a time.

6. The method of claim 1, wherein the subset includes two or more digital images.

7. The method of claim 1, wherein the subset includes five or more digital images.

8. The method of claim 1, wherein the subset includes ten or more digital images.

9. The method of claim 1, wherein the thematic tagging engine includes a crowdsource network.

10. The method of claim 9, wherein the thematic tagging engine includes an interface for receiving input from the crowdsource network.

11. A computer-implemented method for providing contextually relevant advertisements on a digital content platform, the method comprising:
(a) collecting a plurality of digital images from a digital content platform;
(b) providing an interface to display the plurality of digital images to a crowdsource network, wherein the crowdsource network is provided with a pre-defined advertising theme from a service provider, merchant, and/or publisher, and wherein the crowdsource network selects at least one of the digital images based on the pre-defined advertising theme;
(c) providing an interface to identify each digital image selected by the crowdsource network;
(d) maintaining an ad server with at least one ad creative corresponding to the pre-defined advertising theme;
(e) matching the ad creative to at least one digital image selected in step (c); and
(f) providing the ad creative to the digital content platform for publication.

12. The method of claim 11, wherein step (a) includes scraping the digital images from the digital content platform.

13. The method of claim 11, wherein step (a) includes providing an interface for a publisher to submit the digital images.

14. The method of claim 11, wherein the crowdsource network is displayed twelve digital images at a time.

15. The method of claim 11, scoring the digital images.

16. The method of claim 15, wherein the scoring is based on data obtained from the digital content platform that published the digital image.

17. The method of claim 16, wherein the data is selected from the group consisting of: digital publisher identification, publisher priority, image category, image metadata, quality of digital image, size of digital image, date of publication of the digital image, time of publication of digital image, image traffic statistics, and any combination thereof.

18. The method of claim 11, further comprising:
calibrating decisions made by the crowdsource network.

19. The method of claim 11, further comprising:
conducting a second-pass validation.

20. A computer-implemented system for providing contextually relevant advertisements on a digital content platform, comprising:
(a) an interface for collecting a plurality of digital images from one or more digital content platforms;
(b) an interface for displaying subsets of the plurality of digital images to a crowdsource network;
(c) an interface for identifying digital images selected by the crowdsource network based on a pre-defined advertising theme provided to the crowdsource network from a service provider, merchant, and/or publisher;
(d) an ad server storing a plurality of ad creatives, each ad creative including a corresponding theme identifier, wherein the ad server is configured to match an ad creative to at least one digital image selected by the crowdsource network; and
(e) an interface for providing the ad creative, and corresponding match information, to the one or more digital content platforms for publication of the ad creative.

21. The system of claim 20, wherein the selection of digital images is independent of any pre-existing metadata associated with the collected digital images.

22. The method of claim 1, wherein the selection of digital images in step (b) is independent of any pre-existing metadata associated with the digital images collected in step (a).

23. The method of claim 11, wherein the selection of digital images in step (b) is independent of any pre-existing metadata associated with the digital images collected in step (a).

24. A computer-readable storage medium, comprising:
instructions, executable by at least one processing device, which when executed cause the processing device to
(a) display a plurality of digital images to a crowdsource network;
(b) identify digital images selected by the crowdsource network based on a pre-defined advertising theme provided to the crowdsource network from a service provider, merchant, and/or publisher;
(c) match an ad creative to at least one digital image selected by the crowdsource network; and
(d) provide the ad creative to the one or more digital content platforms for publication of the ad creative proximate to the selected digital image.

25. The computer-readable storage medium of claim 24, further comprising:
instructions, executable by at least one processing device, which when executed cause the processing device to display the digital images to the crowdsource network in groups of twelve digital images at a time.

26. The computer-readable storage medium of claim 24, further comprising:
instructions, executable by at least one processing device, which when executed cause the processing device to calibrate decisions made by the crowdsource network.

27. The computer-readable storage medium of claim 24, further comprising:
instructions, executable by at least one processing device, which when executed cause the processing device to conduct a second-pass validation.

28. The computer-readable storage medium of claim 24, wherein selection of digital images by the crowdsource network is independent of any pre-existing metadata associated with the digital images.

29. The computer-readable storage medium of claim 24, further comprising:
instructions, executable by at least one processing device, which when executed cause the processing device to score the digital images based on data obtained from a digital content platform that published the digital images.

30. The computer-readable storage medium of claim 29, wherein the data is selected from the group consisting of: digital publisher identification, publisher priority, image category, image metadata, quality of digital image, size of digital image, date of publication of the digital image, time of publication of digital image, image traffic statistics, and any combination thereof.
